(19) United States
(12) Patent Application Publication
(10) Pub. No.: US 2010/0005492 A1
(43) Pub. Date: Jan. 7, 2010

(54) CONTENT VIEWING SYSTEM

(75) Inventors: Haruko Takano, Kokubunji (JP); Tetsuya Uemura, Sayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/406,248

(22) Filed: Mar. 18, 2009

(30) Foreign Application Priority Data
Jul. 3, 2008 (JP) 2008-174649

(51) Int. Cl. H04N 5/445; H04N 7/16; H04N 7/173

(52) U.S. Cl. 725/46; 725/142; 725/55; 725/116; 726/4

(57) ABSTRACT

The present invention provides a content viewing system constructed so that even when a user uses different content viewing systems, the user's preference information stored on a storage device is used and updated.

The content viewing system includes: a storage device authentication unit that authenticates a removable storage device on which is stored a user's preference information created from a content viewing history in any other content viewing system; a content list acquisition unit that acquires an acquirable content list; a content search unit that reads out the user's preference information from the storage device, refers to the user's preference information that has been read out, and searches for content from the content list; a content acquisition unit that acquires the content detected during the search; and a storage control unit that stores the acquired content on the storage device.

### BACKGROUND OF THE INVENTION

The present invention relates to content viewing systems adapted for users to view programs according to personal preference.

Digital and other TV programs in recent years provide an electronic program guide, allowing users to acquire the electronic program guide via a broadcasting radio wave or the Internet and select any program to be viewed. An increase in the number of channels due to the proliferation of satellite digital broadcasts, terrestrial digital broadcasts, cable TV, and the like, however, has come to require a greater deal of time for the user to search for desired programs from the electronic program guide.

Accordingly, JP-A-2002-44542 and JP-A-H11-75128 disclose the methods that allow a TV program viewing apparatus to present programs to a user's taste according to the user's history of the contents and kinds of past-viewed programs or the user-preset category following completion of program selection from an electronic program guide (EPG), and thus to allow the user to easily search for a program that he or she wishes to view.

### SUMMARY OF THE INVENTION

Along with the proliferation of digital content, terminals for the user to acquire and view the digital content are becoming more advanced in functionality and more diversified. Much of the digital content can be viewed using a wide variety of terminals, without depending upon the terminals. Not a few users possess a plurality of terminals and selectively use the appropriate terminal according to the location of its usage or the like.

Under usage situations such as the above, the techniques in JP-A-2002-44542 and JP-A-H11-75128 where the recommended content is determined on the basis of, for example, the user's viewing history or recording history retained only in the terminal which was used for viewing may not allow the user's preference to be reflected properly.

For example, even if a user who uses both a TV program viewing apparatus and a personal computer as his or her viewing terminals repeatedly views a documentary program a plurality of times for a long time with the personal computer, since this user's viewing history in the personal computer will not be incorporated into the TV program viewing apparatus, the documentary program will not be presented as the recommended program to the user during the use of the TV program viewing apparatus.

An aspect of the present invention is a content viewing system including: a storage device authentication unit that authenticates a removable storage device on which is stored a user's preference information created from a content viewing history in another content viewing system; a content list acquisition unit that acquires an acquirable content list; a content search unit that reads out the user's preference information from the storage device, refers to the user's preference information that has been read out, and searches for content from the content list; a content acquisition unit that acquires the content detected during the search; and a storage control unit that stores the acquired content on the storage device.

Another aspect of the present invention is a content viewing system including: a removable storage device for storage of a user's preference information associated with an identifier of the storage device; a content search unit adapted so that when the removable storage device is not connected, the searching unit reads out the user's preference information from the storage device and searches for content corresponding to the user's preference information that has been read out; and a storage control unit adapted so that when the content that has been detected during the search is being broadcast and is neither being viewed nor being recorded, the storage control unit associates the content with the identifier and stores the content on the storage device.

Yet another aspect of the present invention is a content viewing system including: a storage device authentication unit that authenticates a removable storage device in which a user's preference information is retained; a transmitting unit that reads out from the storage device the user's preference information retained in the authenticated storage device, and transmits the information to a server via the Internet; a receiving unit that receives content recommendations lists transmitted from the server; a display unit that displays the received content recommendations lists; a content selection unit that selects content from the displayed content recommendations lists; a content-receiving unit that receives the selected content from the server; a receiving unit that receives the user's new preference information obtained by updating in the server; and a recording unit that records the received content and user's new preference information on the storage device.

Even when the user uses different terminals (content viewing systems) according to usage location or the like, if a storage device is connected to these terminals to view or record content, preference information can be used at each terminal to which the storage device has been connected, and the user's usage history of each connection destination terminal can be incorporated into the preference information. Content that better matches the user's preference can therefore be recommended to the user.

### BRIEF DESCRIPTION OF THE DRAWINGS

These and other features, objects and advantages of the present invention will become more apparent from the following description when taken in conjunction with the accompanying drawings, wherein:

FIG. 1 is a block diagram showing a configuration of a content viewing system;

FIG. 2 is a flow diagram of monitor display of recommended content;

FIG. 3 is an electronic program guide;

FIG. 4 is a flow diagram of a sequence in which a user's preference information is updated according to his or her viewing history;

FIG. 5 shows an example in which the user applies two digital TV receivers to use the system;

FIG. 6 is a flow diagram of preference information recording on a built-in storage device of the content viewing system as well as on a portable storage device;

FIG. 7 is a flow diagram of a process conducted when a portable storage device is connected to the content viewing system;

FIG. 8 shows an example of displaying recommended-content lists classified according to serial number; and

FIG. 9 is a block diagram showing a configuration of another content viewing system.

### DESCRIPTION OF THE PREFERRED EMBODIMENTS

Content viewing systems according to embodiments are described below.

### First Embodiment

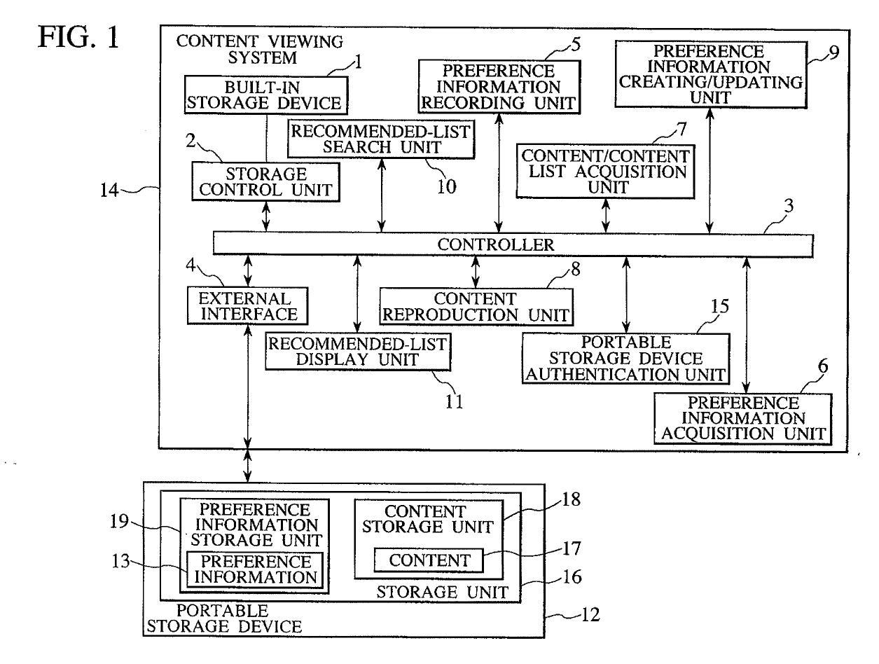

FIG. 1 is a block diagram showing a configuration of a content viewing system according to a first embodiment. A portable storage device 12 includes a preference information storage unit 19 for storing preference information 13 on an internal storage unit 16 of the storage device 12, and a content storage unit 18 for storing content 17 on the internal storage unit 19. In the present embodiment, the portable storage device 12, although described below as iVDR (Information Versatile Disk for Removable usage) [registered trademark] that contains a hard-disk drive (HDD), can be a semiconductor memory or an optical disk as long as the device has recording and reproducing capabilities and can be connected to and disconnected from the content viewing system.

A portable storage device authentication unit 15 authenticates the validity of the portable storage device 12 connected to the content viewing system 14, that is, examines whether the storage device 12 is a valid one manufactured in line with a standard, provisions, or the like. The authentication is conducted by verification of an electronic certificate, for example. A content/content list acquisition unit 7 receives the content delivered using, for example, a wireless signal (a terrestrial broadcasting or satellite broadcasting signal), a wired signal (a cable TV signal or the like), or other media. The content/content list acquisition unit 7 also receives a content list delivered in the same way. The content viewing system can acquire the content list, which is a listing of the content usable to the user who possesses the portable storage device 12. The received content is decoded in a content reproduction unit 8 and output to a monitor not shown. The received content list is transmitted to a recommended-content search unit 10. An external interface 4 is, for example, a serial ATA interface for connecting the portable storage device 12 capable of recording TV programs, as with an iVDR drive. Alternatively, the external interface may be a driver of the serial ATA interface, or the like. A storage control unit 2 controls the portable storage device 12 and a storage device 1 built into the system. A preference information acquisition unit 6 acquires from the storage control unit 2 the preference information 13 recorded on the portable storage device 12 connected to the external interface 4, and transmits the acquired preference information 13 to the recommended-content search unit 10.

On the basis of the received preference information 13, the recommended-content search unit 10 searches for the content suiting the user's preference, from the content earlier acquired, and transmits the detected content as recommended content to a recommended-content display unit 11. The recommended-content display unit 11 outputs the recommended content to the monitor not shown. In addition to accepting user selection of content from the recommended content or accepting user selection of content from an electronic program guide, a controller 3 outputs selected content to the monitor to allow viewing by the user, or records the content on the built-in storage device 1 or on the portable storage device 12. During the connection of the portable storage device 12, when the preference information 13 cannot be acquired, a preference information creating/updating unit 9 creates preference information 13 based upon the user's viewing history. When preference information 13 is present, the preference information creating/updating unit 9 also updates the preference information 13 to incorporate the user's viewing history into the information. A preference information recording unit 5 records the created or updated preference information 13 on the preference information storage unit 19 of the portable storage unit 19 under the control of the storage control unit 2.

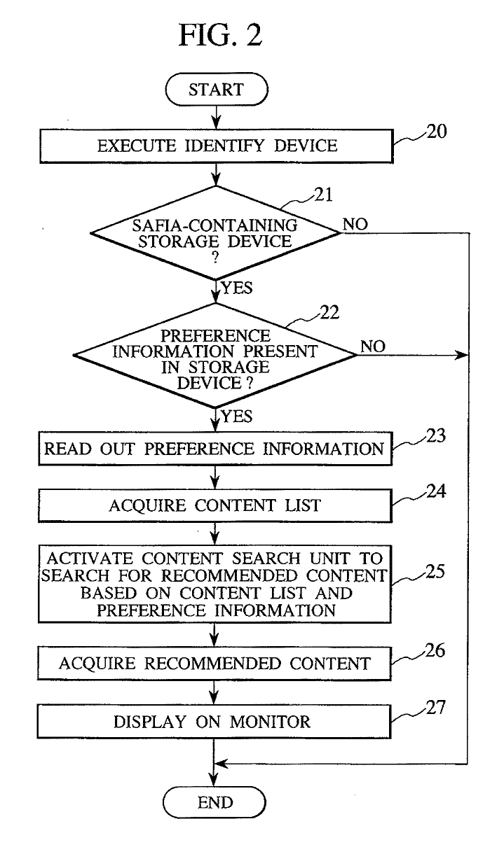

FIG. 2 is a flow diagram relating to displaying the recommended content on the monitor when an iVDR drive with the SAFIA technology installed therein as a content protection standard (copyright protection standard) is connected as the portable storage device 12 to a content-recording digital TV apparatus, an example of the content viewing system 14 according to the present embodiment. The digital TV apparatus, when connected to the iVDR drive, issues an IDENTIFY DEVICE command to the iVDR drive (step 20). The digital TV apparatus then uses a return value of the IDENTIFY DEVICE command to confirm whether the connected portable storage device 12 is the iVDR drive having the installed SAFIA technology that is the content protection standard (step 21).

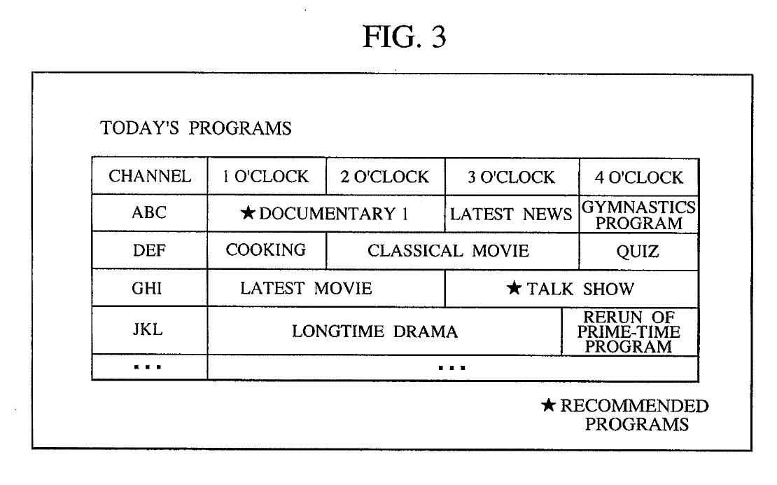

Upon confirming that the portable storage device 12 is the SAFIA-containing iVDR drive, the digital TV apparatus examines in step 22 whether the preference information 13 is stored on the internal preference information storage unit 19 of the SAFIA-containing iVDR drive. If the preference information 13 is stored, the digital TV apparatus reads out the preference information 13 from the preference-information storage unit 19 (step 23). Next after separate content list acquisition in step 24 by the content/content list acquisition unit 7, the digital TV apparatus searches the electronic program guide in step 25 for the TV programs matching the preference information 13. After this, the digital TV apparatus acquires any detected TV programs as the recommended content in step 26 and then as shown in FIG. 3, displays the TV programs on the monitor in step 27.

FIG. 3 is an electronic program guide, in which are listed programs currently being broadcast and programs scheduled to be broadcast on a channel-by-channel basis within several hours of the current time of day. Program names of the TV programs matching the preference information 13 are each preceded by a mark indicating that the program is a recommended one. This allows the user to readily know recommended programs and to select one while watching the display. The content viewing system receives a broadcast of the selected program (content). When a recording reservation instruction for recording one of the recommended programs on the display is assigned from the user or unless, after the reservation of recording of the recommended program, an instruction for canceling the recording of the recommended program is later assigned from the user, the content viewing system acquires, at a broadcasting time of the recommended program, digital data of this recommended program which was acquired by the content/content list acquisition unit 7, and stores the acquired digital data on the content storage unit 18 of the portable storage device 12. The system also updates the preference information 13 to reflect the recording, and stores the updated information on the preference information storage unit 19 of the portable storage device 12.

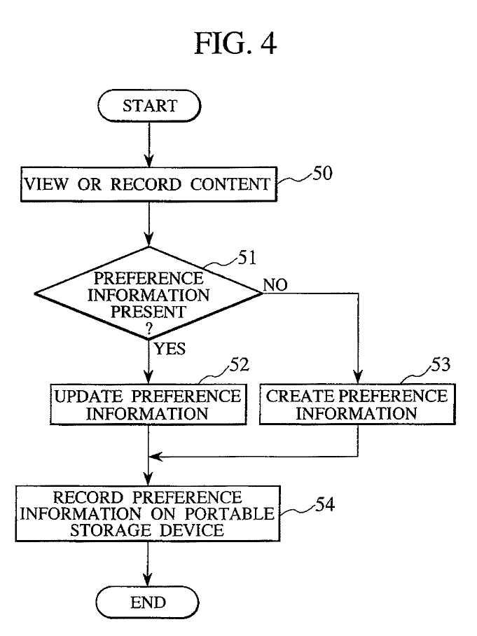

FIG. 4 is a flow diagram of a sequence in which the preference information 13 is updated according to the user's viewing history. The user selects a desired TV program and views/records the program in step 50. If the digital TV apparatus has not yet acquired the preference information 13 from the portable storage device 12, the digital TV apparatus updates the preference information 13 in step 52 on the basis of an operating history of the TV program viewing/recording operations which the user has performed upon the digital TV apparatus, and then records the preference information 13 on the portable storage device 12 in step 54. Conversely if the preference information 13 has not been retained in the portable storage device 12 during the connection thereof and the preference information 13 has not acquired the preference information 13 from the portable storage device 12, the digital TV system creates in step 53 the user's preference information 13 based upon the above user's operating history of the TV program viewing/recording operations, and records the preference information 13 on the portable storage device 12 in step 54.

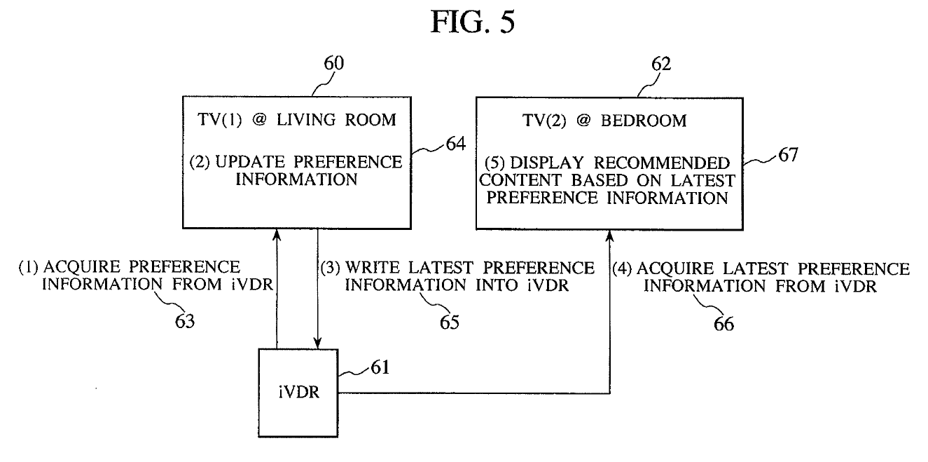

FIG. 5 shows an example in which the user applies two digital TV receivers to use the system.

This example assumes that in addition to a first TV (1) 60 present in a living room, the user has a second TV (2) 62 in a bedroom. When the user views a TV program with the TV (1) 60, he or she connects his or her own iVDR drive 61 to the TV (1) 60 so that he or she can immediately record any favorite program. Upon confirming the connection of the iVDR drive 61, the TV (1) 60 reads out in Step 63 recorded preference information from the iVDR drive 61. In addition, in accordance with the preference information, the TV (1) 60 selects a recommended program to the user's preference, from content lists, and records the selected program in the iVDR drive 61. After this, the TV (1) 60 updates the earlier received preference information in step 64 on the basis of the user's operating history of TV program viewing/recording and other operations upon the TV (1) 60 after the connection of the iVDR drive, and writes the updated preference information into the iVDR drive periodically in step 65.

Next when the user uses the second TV (62) set up in the bedroom, he or she disconnects the iVDR drive 61 from the TV (1) 60) and similarly to the connection of the iVDR drive 61 to the TV (1) 60, connects the iVDR drive to the TV (2) 62 to view any content stored on the iVDR drive or so that any favorite program can be recorded at once. In step 66, the TV (2) 62 reads out recorded preference information 13 from the iVDR drive 61, and then in step 67, presents recommended programs based upon the preference information 13, to the user.

The user can carry preference information 13 and content 17 with him or her by applying the present embodiment and recording the preference information 13 on the portable storage device 12. Even for a terminal that has never been used up to now, for example, even for a terminal that a friend of the user's possesses, or a terminal installed in a hotel or the like, merely connecting the portable storage device 12 to that terminal allows recommended programs to the user's preference to be presented to him or her, and the content 17 to be viewed or stored on the portable storage device 12 through the terminal. In such cases, the user may take some trouble in carrying the portable storage device 12 with him or her and connecting the device 12 to the content viewing system. As a matter of fact, however, the present embodiment does not cause such trouble to the user. This is because just storing the preference information 13 and the content 17 into one storage medium 16 and then executing the conventional operating step of setting the portable storage device 12 in the content viewing system to view or record the content 17 stored on the portable storage device 12 allows the content viewing system to acquire the preference information 13 and the acquisition of content with the preference information 13 incorporated thereinto to be started easily. In addition, a history of content viewing, storing, etc. through the unused terminal can be incorporated into the preference information 13.

The preference information 13 according to the present embodiment is created in accordance with an algorithm predetermined on the basis of a cumulative viewing time, reproduction count, and recording count of specific content or a category to which the content belongs, or the content 17 recorded on the portable storage device 12 or the category to which the content belongs, or other factors. During the creation of the preference information 13, all the above information may be used or part thereof may be used. In addition, information other than the above may be used as long as the user's preference can be identified by the information.

According to the present embodiment, the user's preference information stored on the storage device can be used and updated, even when the user uses different content viewing systems.

### Second Embodiment

A content viewing system 14 according to a second embodiment includes the built-in storage device 1 in addition to the content viewing system configuration employed in the first embodiment, and records the preference information 13 not only on the portable storage device 12 but also on the storage device 1 built into the content viewing system 14. During recording on the built-in storage device 1, the preference information 13 is associated with the serial number (identifier) assigned to the portable storage device 12 on which the preference information 13 is recorded.

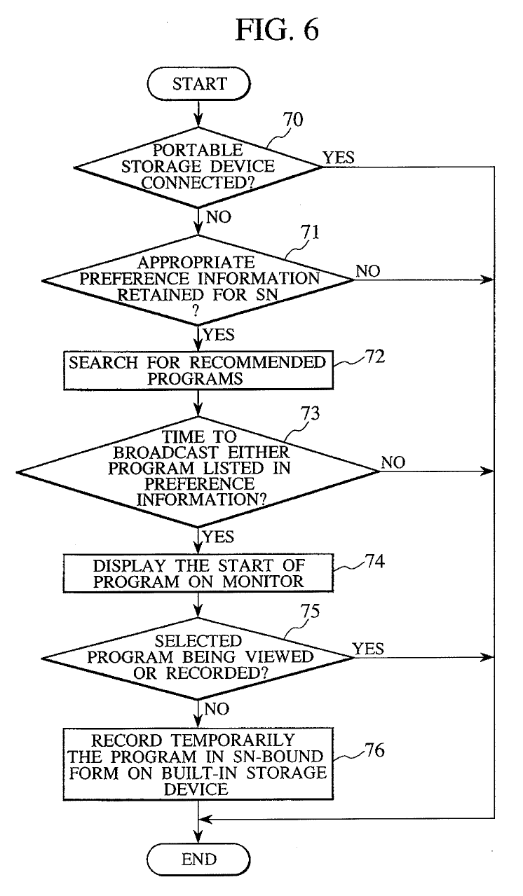

FIG. 6 is a flow diagram of preference information recording on the built-in storage device of the content viewing system as well as on the portable storage device. In FIG. 6, the content viewing system 14 confirms in step 70 whether the portable storage device 12 is connected, and if the storage device 12 is connected, operates in the same way as in the first embodiment. If the portable storage device 12 is not connected, the content viewing system 14 confirms in step 71 whether the preference information 13 associated with the serial number of the portable storage device 12 is recorded on the built-in storage device 1. If the preference information is recorded, recommended content based thereupon is determined from an electronic program guide in step 72.

When the broadcasting time of the recommended content thus determined is reached (step 73), the content viewing system 14 displays the viewing startup time of the recommended content to notify the start of its broadcasting to the user (step 74). If not being viewed or recorded (step 75), the recommended content is associated with the serial number of the portable storage device 12 that has been recorded with the associated preference information, and recorded on the built-in storage device 1 (step 76).

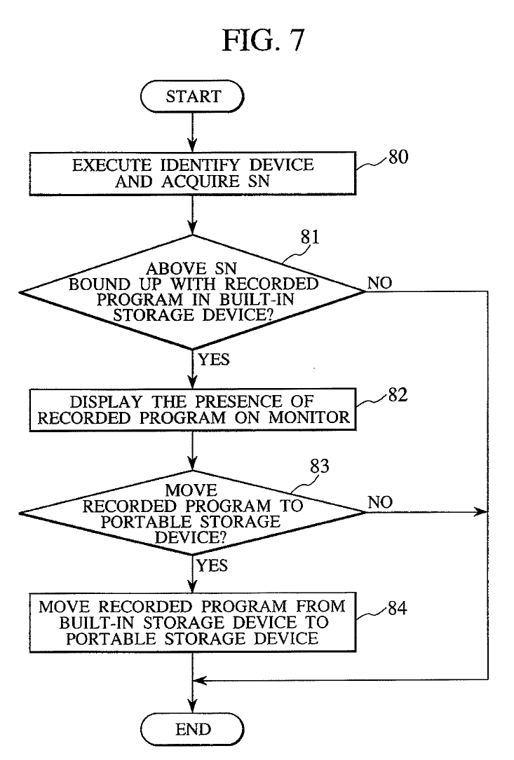

FIG. 7 is a flow diagram of a process conducted next time the portable storage device 12 is connected to the content viewing system 14. The content viewing system 14 issues the IDENTIFY DEVICE command to the connected portable storage device 12 and acquires the serial number thereof (step 80). Next, the system confirms whether the built-in storage device 1 retains recorded content associated with the acquired serial number (step 81). If the recorded content is present, the system informs the user through the monitor that recommended content is recorded on the built-in storage device 1 (step 82), then after receiving a move instruction from the user (step 83), moves the content to the portable storage device 12 in accordance with the move instruction (step 84). Prior to the movement, the system can allow the user to select an operation such as moving the recorded content from the built-in storage device 1 to the portable storage device 12, deleting the content, or leaving the content intact in the built-in storage device 1.

At this time, the system also matches the preference information stored on the built-in storage device 1, and the preference information 13 stored on the portable storage device 12, updates the preference information 13, and stores the same preference information 13 on the built-in storage device 1 and the portable storage device 12. This allows the user to update the preference information as the appropriate preference information 13 by incorporating both the history of the viewing, storage, and other operations that the user performed upon the content viewing system 14 before connecting the portable storage device 12 thereto (this history is included in the preference information existing in the built-in storage device 1), and the history of the viewing, storage, and other operations that the user performed after connecting the portable storage device 12 to other content viewing systems or the like (this history is included in the preference information 13 existing in the portable storage device 12).

Subsequent operation of the content viewing system 14 with the portable storage device 12 connected thereto is the same as in the first embodiment. Additionally, when the portable storage device 12 is later disconnected from the content viewing system 14, since the preference information 13 is already stored on both storage devices, recommended-program searches, content storage, and preference information update operations are properly conducted using the two sets of preference information 13 stored on the storage devices.

In the content viewing system 14 of the present embodiment, the preference information 13 is recorded on the built-in storage device 1 of the content viewing system 14 as well as on the portable storage device 12. At this time, when the preference information is recorded on the built-in storage device 1, the information is associated with the serial number assigned to the portable storage device that retains the preference information.

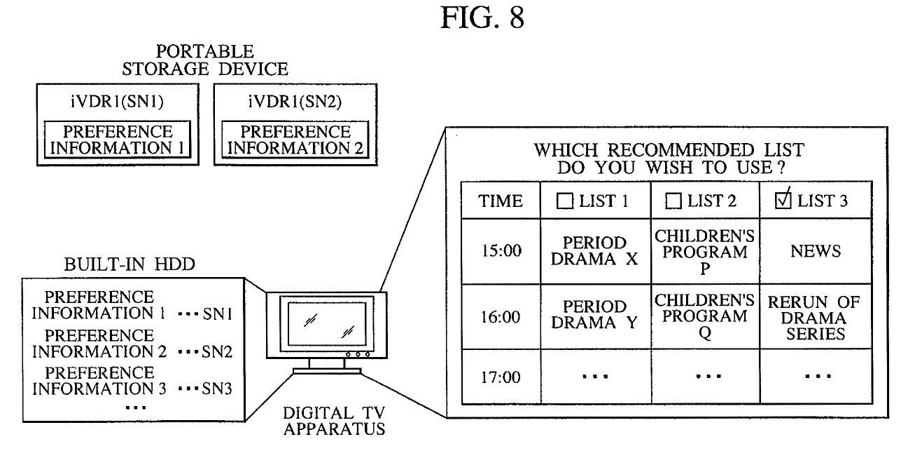

When the portable storage device 12 is not connected, the content viewing system 14 confirms whether preference information is recorded on its built-in storage device 1, and if preference information is recorded, determines recommended content from the electronic program guide, based on the preference information. After that, as shown in FIG. 8, lists of recommended content are displayed in a format classified according to serial number. List 1 in FIG. 8 is a list of recommended content, created on the basis of preference information 1 associated with the serial number of the iVDR 1, and list 2 is a list of recommended content, created on the basis of preference information 2 associated with the serial number of the iVDR 2. The user selects the content list reflecting his or her preference, from the plurality of recommended content lists displayed on the monitor. The content viewing system 14 searches for the recommended content based upon the preference information that the system used to create the content lists, and presents the detected content to the user.

In spite of the portable storage device 12 already being connected during the content search, the portable storage device 12 may not be connected when the content is actually acquired. In that case, after the recommended-content search using the preference information 13 stored on the portable storage device 12, the recommended content can be recorded on the built-in storage device 1 in step 76 in the format associated with the serial number of the portable storage device 12 retaining the particular content in previously associated form with respect to the preference information. In addition, subsequent steps 81 to 84 can be conducted similarly to those of the present embodiment.

### Third Embodiment

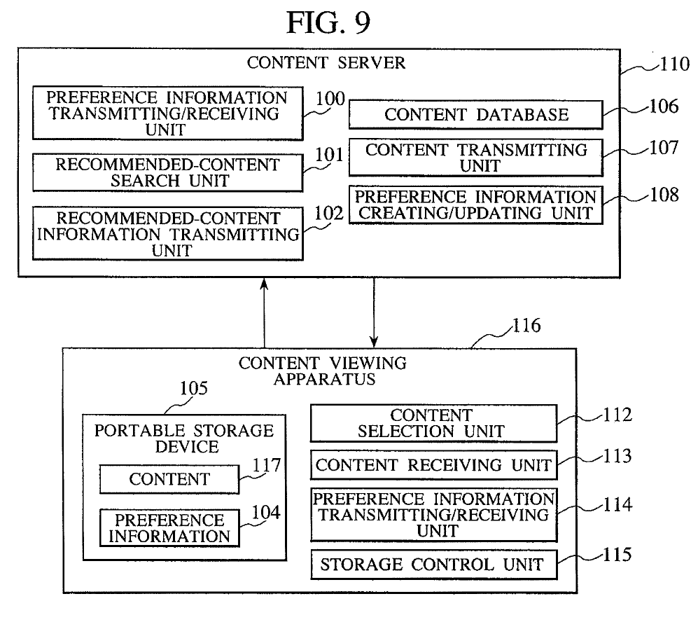

A content viewing system according to a third embodiment is described below. FIG. 9 is a block diagram showing a configuration of the content viewing system according to the present embodiment. The content viewing system 116 includes: a removable, portable storage device 105; a content selection unit 112 for transmitting desired content information to a content server 110; a content receiving unit 113 for receiving the content transferred from the content server 110; a preference information transmitting/receiving unit 114 for transmitting preference information to the content server 110 and receiving the preference information transferred from the content server 110; and more.

The content server 110 includes: a content database 106 with recorded content which the content server 110 can deliver, and with a list of the content; a content transmitting unit 107; a preference information creating/updating unit 108 for generating new preference information and updating the preference information transferred from the content viewing system 116; a preference information transmitting/receiving unit 100 for exchanging preference information with the content viewing system 116; a recommended-content search unit 101 for searching for the content that suits the preference information, from the content database 106; a recommended-content information transmitting unit 102 for transmitting to the content viewing system 116 the recommended content that the recommended-content search unit 101 has searched for; and more.

Upon connection of the portable storage device 105 to the content viewing system 116 by a user, preference information 104 retained in the portable storage device 105 is read out into the content viewing system 116 by a storage control unit 115, and then transmitted from the preference information transmitting/receiving unit 114 to the content server 110 on the Internet. The content server 110 receives from the preference information transmitting/receiving unit 100 the preference information 104 that has been transmitted from the content viewing system 116. Next on the basis of the received preference information, the content server 110 uses the recommended-content search unit 101 to search for the recommended content that suits the user's preference information, from the content database 106. The recommended content is transmitted from the recommended-content information transmitting unit 102 to the content viewing system 116 and then presented to the user through a monitor (not shown) of the content viewing system 116. The user selects desired content from the recommended content that has been presented. The content viewing system 116 then transmits selection information of the user-entered content to the content server 110 via the content selection unit 112.

The content server 110 retrieves the user-selected content from the content database 106 and transmits the content from the content transmitting unit 107 to the content viewing system 116. At the same time, the content server 110 activates the preference information creating/updating unit 108 to incorporate the user-selected content into the preference information 104 that the content viewing system 116 has acquired in advance. After being downloaded via the content receiving unit 113 by the content viewing system, the content that the content server 110 has transmitted is, for example, recorded as content 117 on the portable storage device 105 or reproduced into streaming content using a reproduction unit not shown. Meanwhile, updated preference information is transmitted to the content viewing system 116 via the preference information transmitting/receiving unit 100. The content viewing system 116, after receiving the updated preference information from the preference information transmitting/receiving unit 114, transmits the information to the storage control unit 115. The storage control unit 115 then records on the portable storage device 105 the preference information as preference information 104.

While the above description has been given using a digital TV apparatus as the content viewing system according to the present embodiment, the present invention is not limited to or by the embodiment and can be applied to any other terminal such as a personal computer, DVD recorder, set-top box, car navigation system, stationary or portable audio system, hand-held telephone terminal, and content delivery terminal as long as the portable storage device can be connected to the terminal.

In addition, while the above description has been given using TV programs as the content in the present embodiment, applicable content includes substantially all types of digital content acquired through the Internet, such as audio and video download content and streaming content.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A content viewing system comprising:
a storage device authentication unit for authenticating a removable storage device on which is stored a user's preference information created from a content viewing history in another content viewing system;
a content list acquisition unit for acquiring an acquirable content list;
a content search unit for reading out the user's preference information from the storage device, then referring to the user's preference information that has been read out, and searching for content from the content list;
a content acquisition unit for acquiring the content detected during the search; and
a storage control unit for storing the acquired content on the removable storage device retaining the user's preference information.

2. The content viewing system according to claim 1,
wherein the content list is a list of the content usable to the user, and
wherein the content acquisition unit acquires in response to selection of content from the content list by the user the selected content either by receiving a corresponding broadcast or by downloading from a content server.

3. The content viewing system according to claim 2, wherein the content list is a list of the content acquirable through connection to the content server via a network.

4. The content viewing system according to claim 3, wherein the user's preference information is updated using a viewing history of the acquired content.

5. The content viewing system according to claim 3, wherein the user's preference information is updated using a history of storage of the acquired content on the storage device.

6. The content viewing system according to claim 1, further including a built-in storage device for storing the user's preference information associated with an identifier of the removable storage device,
wherein the content search unit reads out the user's preference information from the built-in storage device or from the removable storage device and then searches for appropriate content according to the user's preference information that has been read out, and
wherein when the content acquisition unit acquires the detected content under an unconnected state of the removable storage device, the storage control unit stores the acquired content on the built-in storage device in a correlated manner with the identifier, and upon connection of the removable storage device, the storage control unit moves the stored content from the built-in storage device to the removable storage device.

7. The content viewing system according to claim 6, wherein under the unconnected state of the removable storage device, the content search unit reads out the user's preference information from the built-in storage device and searches for the appropriate content according to the user's preference information that has been read out.

8. The content viewing system according to claim 6, further including:
a unit for displaying information, in response to the connection of the removable storage device having the identifier, to indicate that the content is stored on the storage device; and
a unit for moving the content from the storage device to the removable storage device in response to a move instruction keyed to the displayed information.

9. A content storage system comprising:
a terminal to which a removable storage device is connected; and
a server connected to the terminal via a network;
wherein the terminal includes a storage device authentication unit for authenticating the removable storage device which retains a user's preference information created from a viewing history of content in an external content viewing system, a first communications unit for transmitting the user's preference information to the server and receiving content from the server, and a storage control unit for storing the received content on the removable storage device retaining the user's preference information, and
wherein the server includes a content list acquisition unit for acquiring an acquirable content list, a content search unit for referring to the user's preference information and searching for content from the content list, a content acquisition unit for acquiring the content detected during the search, and a second communications unit for receiving the user's preference information from the terminal and transmitting the acquired content thereto.

10. A content viewing system comprising:
a storage device authentication unit for authenticating a removable storage device which retains a user's preference information;
a transmitting unit for reading out from the authenticated storage device the user's preference information retained therein and for transmitting the user's preference information to a server over the Internet;
a receiving unit for receiving a recommended-content list transmitted from the server;
a display unit for displaying the recommended-content list that has been received;
a content selection unit for selecting content from the display of the recommended-content list;
a content receiving unit for receiving the selected content from the server;
a receiving unit for receiving the user's new preference information obtained by updating in the server; and
a recording unit for recording the received content and user's new preference information on the storage device.

11. A content storage method comprising the steps of:
a storage device authentication unit authenticating a removable storage device on which is stored a user's preference information created from a viewing history of content in an external content viewing system;
a content list acquisition unit acquiring an acquirable content list;
a content search unit reading out the user's preference information from the storage device, then referring to the user's preference information that has been read out, and searching for content from the content list;
a content acquisition unit acquiring the content detected during the search; and
a storage control unit storing the acquired content on the removable storage device retaining the user's preference information.
